(19) United States
(12) Patent Application Publication
(10) Pub. No.: US 2024/0344156 A1
(43) Pub. Date: Oct. 17, 2024

(54) METALLURGICAL FURNACE WITH CARBON INJECTING LANCE

(71) Applicants: METIX (PROPRIETARY) LIMITED, Morningside (ZA); SMS GROUP GMBH, Düsseldorf (DE)

(72) Inventors: Gabriel Jacobus LOTTER, Morningside (ZA); Edwin Tinashe SANYANGARE, Morningside (ZA); Petrus Paulus Albertus STEYN, Morningside (ZA); Thembela DLAMINI, Morningside (ZA); Gerhardus Scholtz TERBLANCHE, Morningside (ZA); Mark WHITEHEAD, Düsseldorf (DE); Arnd FRANKENBERGER, Düsseldorf (DE)

(21) Appl. No.: 18/631,339

(22) Filed: Apr. 10, 2024

(30) Foreign Application Priority Data
Apr. 12, 2023 (NL) 2034558

(51) Int. Cl. C21C 7/00; C21C 5/52

(52) U.S. Cl. CPC C21C 7/0025; C21C 5/5229

(57) ABSTRACT

The metallurgical furnace comprises a closed vessel enclosing a reducing atmosphere. The vessel comprises at least one electrode providing energy to a burden. The burden comprises a body of molten metal having an upper surface. A carbon injecting lance, in an operational position thereof, extends from an inlet end thereof outside the vessel through a port in the vessel to an outlet end thereof inside the vessel where the lance terminates below the upper surface. The inlet end is connected to a source of carbon. The lance being movable between the operational position and a retracted position wherein the outlet end is outside the vessel. The furnace further comprises a gastight enclosure for the lance when in the retracted position. The enclosure locates on the vessel in gastight manner and over the port and maintains the reducing atmosphere in the vessel.

### INTRODUCTION

### Background

This invention relates to furnaces and more particularly to submerged arc furnaces used in steel making.

In the production of steel by means of known sub-merged arc furnaces (SAF), a hot metal bath containing 0 to 2.5% carbon is produced from direct reduced iron (DRI). This carbon content is too low for the hot metal to be used as an alternative for blast furnace (BF) hot metal in downstream SAF based steelmaking.

### Object of the Invention

Accordingly, it is an object of the present invention to provide a furnace and method of operating a furnace with which the applicant believes the aforementioned disadvantages may at least be alleviated or which may provide a useful alternative for the known furnaces and methods.

### SUMMARY OF THE INVENTION

According to the invention there is provided a metallurgical furnace comprising:
a closed furnace vessel maintaining a reducing atmosphere, the vessel comprising at least one electrode providing energy to a burden in the vessel, the burden comprising a body of molten metal having an upper surface, a layer of slag on the upper surface and a body of feed material;
at least one carbon injecting lance, which in an operational position thereof extends from an inlet end thereof outside the vessel through a port in the vessel to an outlet end thereof inside the vessel where the lance terminates below the upper surface of the metal body; the inlet end of the at least one carbon injecting lance being connected to a source of a carburizing agent; the at least one carbon injecting lance being selectively movable between the operational position and a retracted position wherein the outlet end is outside the vessel, and
a gastight enclosure for the at least one carbon injecting lance when in the retracted position, the enclosure locating over the port on the vessel in gastight manner and maintaining the reducing atmosphere in the vessel.

The furnace may be operating as a submerged arc furnace (SAF), alternatively as an open arc furnace.

The carburizing agent may be in the form of a dried and finely ground carburizing agent and in steel making applications utilizing SAF, the carbon injecting lance may be used to raise the carbon content in the hot metal bath of direct reduced iron (DRI) to larger than 4%, so that it may be used as a blast furnace (BF) alternative hot metal supply in downstream SAF based steel making. The carburizing agent may be in the form of coal, coke, graphite, pure carbon, etc.

The metallurgical furnace may comprise a plurality of carbon injecting lances each extending through a respective port in the vessel; and a respective gastight enclosure for each carbon injecting lance.

In some embodiments, the inlet end of each carbon injecting lance may be connected to a respective source of carburizing agent.

In other embodiments, the plurality of carbon injecting lances may be divided into at least a first set of carbon injecting lances and a second set of carbon injecting lances and the inlet ends of the carbon injecting lances of the first set and the inlet ends of the carbon injecting lances of the second set may be connected to a respective source of carburizing agent.

During operation, the carburizing agent may continuously be fed to the inlet ends of the carbon injecting lances to be ejected at the outlet ends.

In other embodiments, the carburizing agent may sequentially and alternately be fed to the inlet ends of the carbon injecting lances of the first set and the inlet ends of the carbon injecting lances of the second set.

The vessel may be rectangular in configuration comprising: a rectangular base having a main axis extending between opposed ends of the base; opposed rising side walls; opposed rising end walls; and a roof.

The metallurgical furnace may comprise a plurality of spaced electrodes located on the main axis.

In other embodiments, the vessel may be circular in configuration comprising: a base having a main and centre axis; circular sidewalls and a circular roof.

In these embodiments, a plurality of spaced electrodes may be located on a circle concentric with the main axis.

The port may be defined in any suitable part of the vessel, such as the sidewalls, but preferably the port is defined in the roof. The at least one carbon injecting lance may be movable between the operational and retracted positions in a vertically direction or at an incline.

The at least one carbon injecting lance may be mounted on a respective carriage which is movable on a rack between a first position corresponding to the operational position of the at least one carbon injecting lance and a second position corresponding to the retracted position of the at least one carbon injecting lance, the carriage and rack being mounted in the gastight enclosure.

The gastight enclosure may be elongate and may comprise a selectively operable inlet into the enclosure for an inert gas under pressure, a selectively operable vent from the enclosure and a selectively openable and closable door through which at least part of the at least one carbon injecting lance is removable from the enclosure.

A lid for the port may be mounted in the enclosure. The lid may be selectively movable between an open and a closed position, when the at least one carbon injecting lance is in the retracted position.

Also included within the scope of the invention is a method of operating a metallurgical furnace comprising a closed furnace vessel maintaining a reducing atmosphere, the vessel comprising at least one electrode providing energy to a burden in the vessel, the burden comprising a body of molten metal having an upper surface, a layer of slag on the upper surface and a body of feed material; the method comprising:
utilizing a carbon injecting lance which, when in an operational position, extends from an inlet end thereof outside the vessel through a port in the vessel to an outlet end of the carbon injecting lance below the upper surface, to inject carburizing agent into the burden;
selectively retracting the carbon injecting lance to a retracted position such that the outlet end is located outside the vessel; and
utilizing a gastight enclosure for housing the carbon injecting lance when in the retracted position, which enclosure locates over the port and in gastight manner on the vessel, to maintain the reducing atmosphere in the vessel.

### BRIEF DESCRIPTION OF THE ACCOMPANYING DIAGRAMS

The invention will now further be described, by way of example only, with reference to the accompanying diagrams wherein:

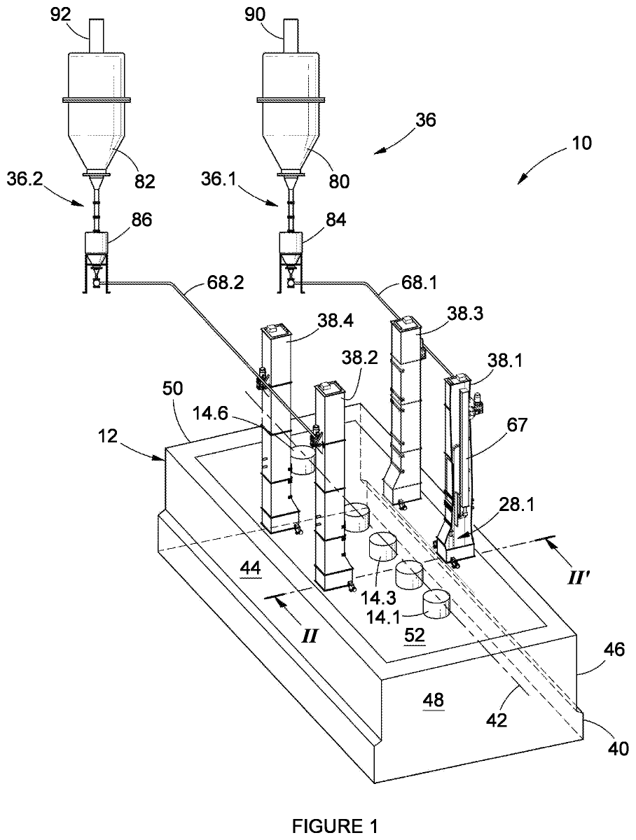

FIG. 1 is a diagrammatic perspective view of an example embodiment of a metallurgical furnace comprising a vessel having a roof and carbon injecting lances extending through the roof into the vessel.

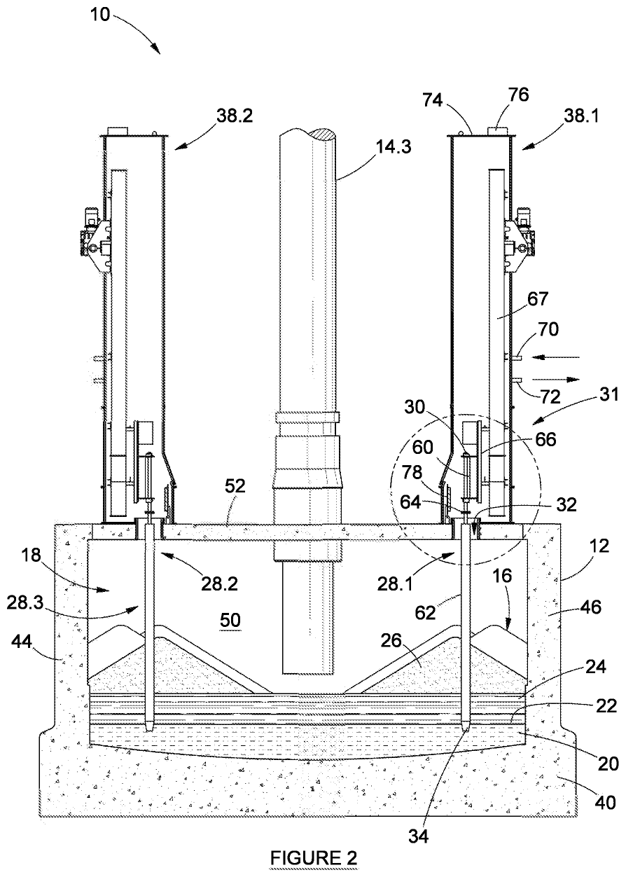

FIG. 2 is a section on line II in FIG. 1 showing the lances in an operational position relative to the vessel.

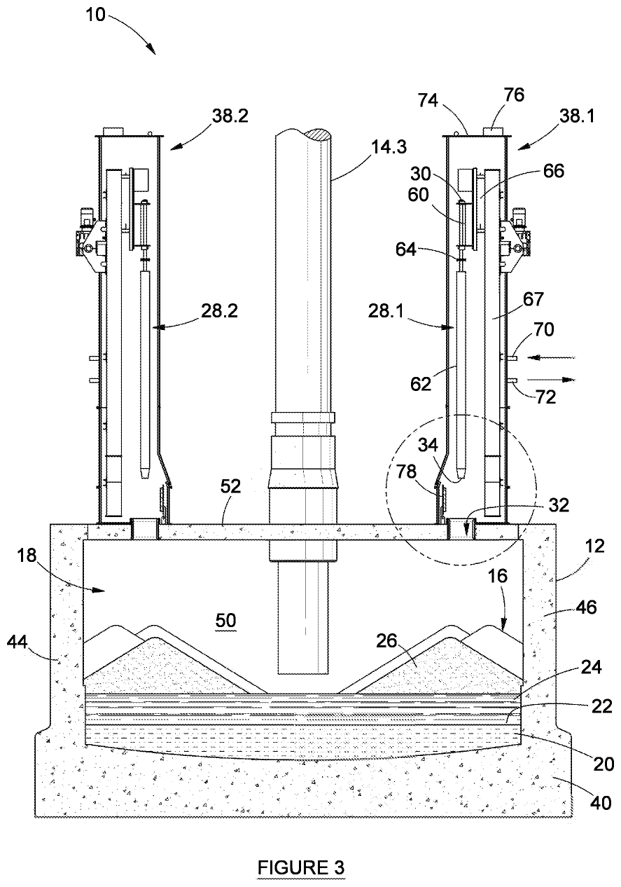

FIG. 3 is a similar view with the lances in a retracted position relative to the vessel.

FIG. 4 is an enlarged sectional view of a region of the roof defining a port through which a lance, in its operational position, extends into the vessel.

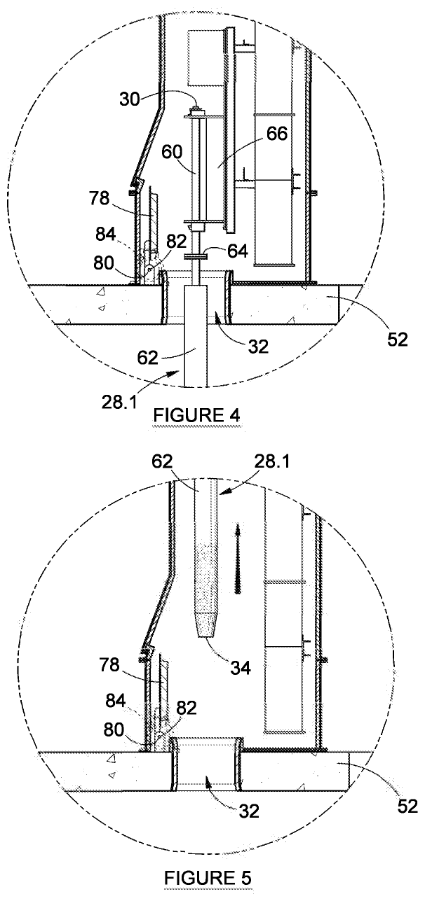

FIG. 5 is a view similar to FIG. 4, but with the lance in the retracted position.

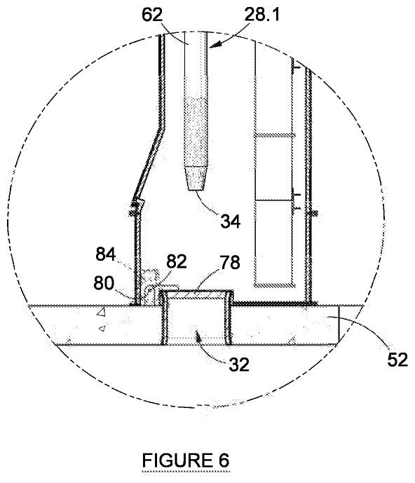

FIG. 6 is a view similar to FIG. 5, but with the port closed with a lid.

### DESCRIPTION OF A PREFERRED EMBODIMENT OF THE INVENTION

An example embodiment of a metallurgical furnace is generally designated by the reference numeral 10 in FIGS. 1 to 3.

The metallurgical furnace 10 comprises a closed furnace vessel 12 enclosing and maintaining a reducing atmosphere. The vessel comprises at least one electrode 14.1 to 14.6 providing energy to a burden 16 (shown in FIGS. 2 and 3) in a chamber 18 of the vessel. The burden 16 comprises a body of molten metal 20 having an upper surface 22, a layer of slag 24 on the upper surface and a body of feed material 26. At least one carbon injecting lance 28.1 to 28.4, which in an operational position thereof (shown in FIG. 2) extends from an inlet end 30 thereof outside the vessel through a port 32 in the vessel to an outlet end 34 thereof inside the vessel where the lance terminates below the upper surface 22 of the metal body 20. The inlet end 30 of the lance is connected to a source of a carburizing agent 36 (shown in FIG. 1). The at least one lance being selectively movable between the operational position and a retracted position (shown in FIG. 3) wherein the outlet end 34 is outside the vessel 12. The furnace further comprises a gastight enclosure 38.1 to 38.4 for the at least one lance when in the retracted position. The enclosure locates on the vessel in gastight manner and over the port 32 and maintains the reducing atmosphere in the vessel.

In the example embodiment shown in FIGS. 1 to 3, the furnace vessel 12 is rectangular in configuration and comprises a rectangular base 40 having a main axis 42 extending between opposed ends of the base. The vessel further comprises opposed rising side walls 44, 46, opposed rising end walls 48, 50 and a roof 52.

In the example embodiment of FIGS. 1 to 3, the furnace 10 comprises six electrodes 14.1 to 14.6 spaced from one another on the longitudinal axis 42.

The furnace is typically located in a building (not shown) comprising a steel structure or frame (not shown) for supporting furnace components in known manner. A control room (also not shown) with a central furnace and process controller (also not shown) is also provided. All required measured values from the furnace system are displayed on a human machine interface (HMI) in the control room.

The furnace may comprise a plurality of similar carbon injecting lances. In some embodiments ten lances may be provided, but in the embodiment shown, four lances 28.1 to 28.4 are provided. Since the carbon injecting lances are similar in configuration, carbon injecting lance 28.1 only will be described in further detail. The lance 28.1 is tubular in configuration and a bore thereof extends between the inlet end 30 for the carburizing agent and the outlet end 34 thereof. The carburizing agent is provided by the source 36 and is in the form of a dried and finely ground carburizing agent entrained in an inert gas. As best shown in FIGS. 1, 2 and 4 to 6, the lance 28.1 comprises a first permanent part 60 and a second consumable and replaceable part 62 which are joined at mutually cooperating flanges 64 in fluid tight manner. The consumable part comprises thick-walled steel tube which is externally coated with a high alumina castable.

Hence, in addition to a conventional feed system (not shown) for solid feed material 16 (shown in FIGS. 2 and 3) required for steel-making, the metallurgical furnace 10 is connected to the source 36 for receiving, storing, handling the finely ground carburizing agent. The plurality of carbon injecting lances 28.1 to 28.4 serve to inject the carburizing agent into the burden at a level below the upper surface 22 of the metal body.

The carbon injecting lance 28.1 is carried by a moving carriage 66 on a vertical rack 67 on a mast, both located in the enclosure 38.1. The first part 62 of the injecting lance is secured onto the moving carriage 66, preferably by a pneumatically operated, self-locking, clamping device. The inlet end 30 of the lance is connected to a powder conveying line 68.1 by a pneumatically actuated coupling device. The clamping device and the coupling device are controlled from a local control panel.

The carriage 66 is selectively movable (raised or lowered) as required, by a heavy-duty duplex endless chain mounted on the mast and connected to both upper and lower ends of the carriage 66. The chain is driven by an inverter controlled geared motor unit (not shown) to give variable speed and good position control as it travels up and down the mast during operation. An encoder monitors the position of the carriage 66, and fixed limit switches give final end position signals.

Hence, with the carriage selectively movable as stated above, the carbon injecting lance 28.1 is also selectively movable between the operational position (shown in FIG. 2) wherein the second end 34 thereof is located below the upper surface 22 of the metal body 20 and the retracted position (shown in FIG. 3) wherein the second part 60 of the lance may be serviced or replaced.

The metallurgical furnace further comprises a respective gastight enclosure 38.1 to 38.4 for each of the carbon injecting lances when in the retracted position. The enclosures are similar in configuration and therefore enclosure 38.1 only will be described in more detail below. In the example embodiment, the gastight enclosure 38.1 is mounted on the roof 52 of the furnace in gastight manner and over the port 32. The enclosure is elongate to accommodate the mast, rack and the injecting lance 28.1 when in the retracted position. The enclosure comprises a selectively operable inlet 70 into the enclosure for an inert gas under pressure, a selectively operable vent 72 from the enclosure and a selectively openable and closable door 74 through which at least part of the at least one carbon injecting lance is removable from the enclosure. The enclosure further comprises a pressure release valve 76. In operation, the enclosure 38.1 which is filled with the inert gas at a pressure higher than the pressure in the chamber 18, “stops” the port 32 when the lance 28.1 is in the first position. The so stopped port 32 prevents gasses in chamber 18 from egressing or escaping from the chamber while the lance is in the operational position. The enclosure and stopped port also prevent oxygen from ingressing into the chamber, thereby maintaining the reducing atmosphere in the vessel.

The metallurgical furnace further comprises a selectively operable lid 78 for the port 32. The lid 78 is mounted in the enclosure 38.1 and is pivotable about a hinge 80 by a rotating shaft 82 which is selectively driven by a pneumatic actuator 83. The lid is hence selectively movable between an open position (shown in FIGS. 2 to 5) and a closed position (shown in FIG. 6) when the carbon injecting lance 28.1 in the enclosure 38.1 is in the retracted position. As shown in FIG. 6, once the second end is in the second position, the pneumatic actuator 83 pivots the lid 78 to the closed position and the lid then seals the port 32. During maintenance activities, the enclosure 38.1 is then evacuated through vent 72 of the inert gas by connection to the furnace fume extraction system and fresh air is allowed into the enclosure to further cool the lance and remove asphyxiation risk. The door 74 in enclosure 38.1 is opened and the lance may be removed, to replace the second part 62 by a new second part, to form a new lance.

In some embodiments (not shown) each injecting lance may be connected via a respective conveying line to a respective source of carburizing agent. In these embodiments and with the lance in the operational position, the carburizing agent may be fed on a continuous basis to each lance to be ejected below the surface 22.

In other embodiments, the plurality of lances may be divided into at least a first set of lances and a second set of lances. This is illustrated in FIG. 1 where the lances in enclosures 38.1 and 38.3 are in the first set and the lances in enclosures 38.2 and 38.4 are in the second set. The lances of the first set are connected via conveying line 68.1 to a first source part 36.1 and the lances of the second set are connected via conveying line 68.2 to a second source part 36.2. In this embodiment and with the lances in the operational position, the carburizing agent may be fed on a continuous basis to all the lances to be ejected below the surface 22. Alternatively, the carburizing agent is sequentially and alternately fed to the inlet ends of the carbon injecting lances of the first set and the inlet ends of the carbon injecting lances of the second set.

Still referring to FIG. 1, the source 36 may comprise first and second external receiving and storage silos 80, 82 for the powdered carburizing agent. Directly below each storage silo is an injection dispenser 84, 86. An outlet of the injection dispenser is connected by a powdered carburizing agent conveying line 68.1, 68.2 which feed the two sets of injecting lances.

The material level inside the silo is continuously monitored by a full-length level radar type probe (not shown). Mounted on the top of the silo is a self-cleaning, displacement air filter 90, 92. Displaced air resulting from filling, fluidizing and venting passes through the filters which prevent dust from being discharged to the atmosphere. The silo is also equipped with an overpressure sensing transmitter and an over pressure rupture disc unit.

The injection dispensers are pressure vessels. Both dispensers are supported by free-standing frames and mounted on load cells (not shown) to measure the contents. This measurement is used for controlling the injection flow rate, powder flow control valve position as well as high and low levels in the dispensers. The dispensers are equipped with flanged connections for a vent line, a pressurization line and a fluidization line, together with instrumentation for pressure measurement.

A series of valves are located below the dispenser for isolation and material flow control. The dispensers are connected to the powder conveying lines 68.1 and 68.2 which feed the first and second sets of injecting lances. The powder conveying lines comprise heavy duty shot blast hose with quick release connections for ease of exchange, when required.

Nitrogen is used as a transport gas for conveying, fluidizing and injection of the powdered carburizing agent. The nitrogen pressure and flow rate are controlled by a set of valves (not shown).

During carbon injection in the first position of the lance 28.1, the actual rate of injection is measured by the above load cells on which the powder injection dispenser is mounted and calculated by the control system. The actual achieved injection rate is compared with the required injection rate on a continuous basis. Any difference between the measured rate and the required rate is used to modulate the material flow control valve below the injection dispenser. This valve opens or closes automatically to increase or decrease the actual rate of injection in order to maintain the pre-set rate.

The source 36 will continue to inject from one or both dispensers until it is almost empty or a lance exchange is required or a fault in the system occurs, whereby the injection is no longer possible or deemed to be impractical. The injection is stopped automatically as the material level reaches a low limit or when an operator initiates a stop sequence from the control system or automatically, in the case of a fault scenario.

The lance 28.1 begins to retract by the carriage 66 moving it towards the second position and the second end 34 leaves the burden and surface of the slag. Once the second end is clear of the slag surface, the injection dispenser shut off valve is closed and powder stops leaving the dispenser. The powder still in the powder conveying line 68.1 is blown through the lance onto the slag surface. Once all the powder has been discharged from the lance, the transport gas continues to flow for a short period of time, at an increased flow rate, to ensure the powder conveying line 68.1 is clear, and then shuts off. The lance continues to move towards its retracted parked position. When the injection lance reaches the end of its usable life or has failed or blocked prematurely it may be removed through door 74. A new second part 62 may be fitted as stated above. The new lance is then inserted into the enclosure 38.1, connected to the carriage 66 and the inlet end 30 is connected to the conveying line 68.1.

When required for service, the new lance is then lowered towards the operational position. Before the outlet end 34 enters the hot slag surface, the powder transport gas is switched on, the lance pauses until the gas flow rate is stable and then the powder outlet valve on the injection dispenser is opened, allowing powder to flow out into the powder conveying line 68.1 and through the lance. Once a minimum powder flow rate is established, the lance is driven down into the burden with the outlet end 34 at the predetermined position below the surface 22 of the metal body 20. The powder flow is established before the lance enters the slag and maintained until the lance leaves the slag to prevent blockage of the lance outlet.

1. A metallurgical furnace comprising:
a closed furnace vessel maintaining a reducing atmosphere, the vessel comprising at least one electrode providing energy to a burden in the vessel, the burden comprising a body of molten metal having an upper surface, a layer of slag on the upper surface and a body of feed material;
at least one carbon injecting lance, which in an operational position thereof extends from an inlet end thereof outside the vessel through a port in the vessel to an outlet end thereof inside the vessel where the lance terminates below the upper surface of the metal body; the inlet end of the at least one carbon injecting lance being connected to a source of a carburizing agent; the at least one carbon injecting lance being selectively movable between the operational position and a retracted position wherein the outlet end is outside the vessel, and
a gastight enclosure for the at least one carbon injecting lance when in the retracted position, the enclosure locating over the port on the vessel in gastight manner and maintaining the reducing atmosphere in the vessel.

2. The metallurgical furnace as claimed in claim 1 comprising a plurality of carbon injecting lances each extending through a respective port in the vessel; and a respective gastight enclosure for each carbon injecting lance.

3. The metallurgical furnace as claimed in claim 2 wherein the inlet end of each carbon injecting lance is connected to a respective source of a carburizing agent.

4. The metallurgical furnace as claimed in claim 2 wherein the plurality of carbon injecting lances are divided into at least a first set of carbon injecting lances and a second set of carbon injecting lances and wherein the inlet ends of the carbon injecting lances of the first set and the inlet ends of the carbon injecting lances of the second set are connected to a respective source of a carburizing agent.

5. The metallurgical furnace as claimed in claim 3 wherein, during operation, carburizing agent is continuously fed to the inlet ends of the carbon injecting lances to be ejected at the outlet ends.

6. The metallurgical furnace as claimed in claim 4 wherein the carburizing agent is sequentially and alternately fed to the inlet ends of the carbon injecting lances of the first set and the inlet ends of the carbon injecting lances of the second set.

7. The metallurgical furnace as claimed in claim 1 wherein the vessel is rectangular in configuration comprising: a rectangular base having a main axis extending between opposed ends of the base; opposed rising side walls; opposed rising end walls; and a roof.

8. The metallurgical furnace as claimed in claim 7 comprising a plurality of spaced electrodes located on the main axis.

9. The metallurgical furnace as claimed in claim 1 wherein the vessel is circular in configuration comprising: a base; circular sidewalls and a circular roof.

10. The metallurgical furnace as claimed in claim 9 comprising a plurality of spaced electrodes located on a circle concentric with the main axis.

11. The metallurgical furnace as claimed in claim 7 wherein the port is defined in the roof and wherein the at least one carbon injecting lance is movable between the operational and retracted positions vertically or at an incline.

12. The metallurgical furnace as claimed in claim 1 wherein the at least one carbon injecting lance is mounted on a respective carriage which is movable on a rack between a first position corresponding to the operational position of the at least one carbon injecting lance and a second position corresponding to the retracted position of the at least one carbon injecting lance, the carriage and rack being mounted in the gastight enclosure.

13. The metallurgical furnace as claimed in claim 1 wherein the gastight enclosure is elongate and comprises a selectively operable inlet into the enclosure for an inert gas under pressure, a selectively operable vent from the enclosure and a selectively openable and closable door through which at least part of the at least one carbon injecting lance is removable from the enclosure.

14. The metallurgical furnace as claimed in claim 1 comprising a lid for the port which is mounted in the enclosure, the lid being selectively movable between an open and a closed position when the at least one carbon injecting lance is in the retracted position.

15. A method of operating a metallurgical furnace comprising a closed furnace vessel maintaining a reducing atmosphere, the vessel comprising at least one electrode providing energy to a burden in the vessel, the burden comprising a body of molten metal having an upper surface, a layer of slag on the upper surface and a body of feed material; the method comprising:
utilizing a carbon injecting lance which, when in an operational position, extends from an inlet end thereof outside the vessel through a port in the vessel to an outlet end of the carbon injecting lance below the upper surface, to inject a carburizing agent into the burden;
selectively retracting the carbon injecting lance to a second retracted position such that the outlet end is located outside the vessel; and
utilizing a gastight enclosure for the carbon injecting lance when in the retracted position, which enclosure locates over the port and in gastight manner on the vessel, to maintain the reducing atmosphere in the vessel.
